(19) United States
(12) Patent Application Publication
(10) Pub. No.: US 2022/0134346 A1
(43) Pub. Date: May 5, 2022

(54) WELDING SLAG CLEANING DEVICE, WELDING MACHINE HEAD AND WELDING SYSTEM

(71) Applicant: CHINA CONSTRUCTION SCIENCE AND INDUSTRY CORPORATION LTD., Shenzhen, Guangdong (CN)

(72) Inventors: Zhenming CHEN, Shenzhen, Guangdong (CN); Qingchuan FENG, Shenzhen, Guangdong (CN); Dongrong XIE, Shenzhen, Guangdong (CN); Zhizhen LV, Shenzhen, Guangdong (CN); Zhiyong ZUO, Shenzhen, Guangdong (CN); Shitao HUANG, Shenzhen, Guangdong (CN); Chengli XIE, Shenzhen, Guangdong (CN)

(21) Appl. No.: 17/433,148

(22) PCT Filed: Jul. 31, 2020
(86) PCT No.: PCT/CN2020/106397

§ 371 Date: Aug. 23, 2021

(30) Foreign Application Priority Data
Nov. 26, 2019 (CN) 201911170312.6

(51) Int. Cl. B02C 7/12; B23K 9/32; B23K 9/18

(52) U.S. Cl. CPC B02C 7/12; B02C 2201/00; B23K 9/18; B23K 9/32

(57) ABSTRACT

Disclosed are a welding slag clearing device, a welding machine head and a welding system. The welding slag clearing device includes: a mounting frame; a slag crushing mechanism comprising a slag crushing wheel and an adjusting assembly, the slag crushing wheel is connected to the adjusting assembly, the adjusting assembly is connected to the mounting frame, and the adjusting assembly is configured to adjust a longitudinal distance of the slag crushing wheel relative to the mounting frame; and a welding slag recovery mechanism comprising a hollow recovery pipe and a connecting piece used for connecting the recovery pipe with the mounting frame, the recovery pipe is correspondingly arranged right behind the slag crushing mechanism in a transverse direction.

### TECHNICAL FIELD

The present invention relates to the field of automatic machining technologies, and more particularly, to a welding slag cleaning device, a welding machine head and a welding system.

### BACKGROUND

Welded H-shaped steel is an important component of a steel structure piece, which is widely used in steel structure engineering with the advantages of arbitrary machining, design and combination. In the manufacturing industry of steel building structure in China, there are a large number of welded H-shaped steel beams with a simple structure (multi-dimensional uniform cross section), which are generally welded through an automatic submerged arc welding machine. The automatic submerged arc welding machine may automatically recover excess welding flux during welding, but coated welding slag on a weld surface protecting a molten pool cannot be automatically cleaned and recovered, which are usually cleaned and collected manually after being crushed through a planer hammer by a submerged arc welding operator.

In the machining industry of steel structure, the cleaning of the welding slag of the H-shaped steel is an action that spends the longest labor time in submerged arc welding, which is a key factor that it is still necessary to operate one machine by one operator since the submerged arc welding is widely used, and is also a main bottleneck to improve per capita work efficiency.

### SUMMARY

The present invention aims to address at least one of the technical problems in the existing technology. Therefore, the present invention provides a welding slag cleaning device, which is capable of automatically cleaning welding slag, liberating manpower and effectively improving per capita work efficiency.

The present invention further provides a welding machine head and a welding system with the welding slag cleaning device.

In a first aspect, an embodiment of the present invention provides a welding slag cleaning device, which includes:

a mounting frame; a slag crushing mechanism including a slag crushing wheel and an adjusting assembly, wherein the slag crushing wheel is connected to the adjusting assembly, the adjusting assembly is connected to the mounting frame, and the adjusting assembly is configured to adjust a longitudinal distance of the slag crushing wheel relative to the mounting frame; and a welding slag recovery mechanism including a hollow recovery pipe and a connecting piece used for connecting the recovery pipe with the mounting frame, wherein the recovery pipe is correspondingly arranged right behind the slag crushing mechanism in a transverse direction.

The welding slag cleaning device according to the embodiment of the present invention at least has the following beneficial effects.

The slag crushing mechanism is configured to crush welding slag, the welding slag recovery mechanism is used for recovering the welding slag crushed by the slag crushing mechanism, and the welding slag cleaning device is moved in a welding direction, so that the welding slag is automatically cleaned, manpower is liberated, and per capita work efficiency is effectively improved.

In the welding slag cleaning device according to other embodiments of the present invention, the slag crushing wheel includes a wheel axle and a wheel body, and is rotationally connected to the adjusting assembly through the wheel axle; and gear teeth are distributed on the wheel body, and the gear teeth are configured to crush the welding slag.

In the welding slag cleaning device according to other embodiments of the present invention, the adjusting assembly includes a guide rod, a mounting piece and an elastic piece, the mounting piece is connected to one end of the guide rod, and the slag crushing wheel is rotationally connected to the mounting piece through the wheel axle; the guide rod is connected to the mounting frame and is capable of moving relative to the mounting frame in a longitudinal direction, and an upper end of the guide rod is provided with a limiting structure; and the guide rod is arranged between the mounting frame and the mounting piece, and the guide rod has an elastic force to make the mounting piece far away from the mounting frame in a longitudinal direction.

In the welding slag cleaning device according to other embodiments of the present invention, the adjusting assembly includes an adjusting piece and a mounting piece, the mounting piece is connected to one end of the adjusting piece, and the slag crushing wheel is rotationally connected to the mounting piece through the wheel axle; and the adjusting piece is connected to the mounting frame, and by adjusting a connection position of the adjusting piece to the mounting piece, a longitudinal distance of the mounting piece relative to the mounting frame is capable of being adjusted.

In the welding slag cleaning device according to other embodiments of the present invention, the gear teeth are of a conical structure.

In the welding slag cleaning device according to other embodiments of the present invention, a lower end port of the recovery pipe is set as a convergent structure.

In the welding slag cleaning device according to other embodiments of the present invention, the lower end port of the recovery pipe is convergent to form the convergent structure with an elliptical or runway-shaped cross section.

In the welding slag cleaning device according to other embodiments of the present invention, a front end of the lower end port of the recovery pipe is provided with a chamfered opening.

In the welding slag cleaning device according to other embodiments of the present invention, the recovery device further includes a recovery box, the recovery box is communicated with the recovery pipe through a pipeline, and the recovery box is used for connecting with a negative pressure air source to provide negative pressure suction for the recovery pipe.

In a second aspect, an embodiment of the present invention provides a welding machine head, which includes a front wire welding gun, a rear wire welding gun, a welding flux recovery pipe and the welding slag cleaning device according to any one of the above embodiments which are sequentially arranged from front to back in a transverse direction, wherein the slag crushing wheel is correspondingly located right behind the welding flux recovery pipe in the transverse direction, and a set distance is spaced between the slag crushing wheel and the rear wire welding gun.

The welding machine head according to the embodiment of the present invention at least has the following beneficial effects.

The slag crushing wheel of the welding slag cleaning device is correspondingly located right behind the welding flux recovery pipe in the transverse direction, so that welding, welding flux recovery and online cleaning of the welding slag are capable of being implemented, manpower is capable of being liberated, and per capita work efficiency is effectively improved.

The welding machine head according to other embodiments of the present invention includes a lifting arm and a backboard extending in a transverse direction, wherein the backboard is directly connected to the lifting arm, the front wire welding gun, the rear wire welding gun, the welding flux recovery pipe and the welding slag cleaning device are all mounted on the backboard, and the front wire welding gun, the rear wire welding gun, the welding flux recovery pipe, the slag crushing wheel and the recovery pipe are aligned with each other in the transverse direction.

In a third aspect, an embodiment of the present invention provides a welding system, which includes the welding machine head according to any one of the above embodiments.

The welding system according to the embodiment of the present invention at least has the following beneficial effects.

The welding system includes the above welding machine head, which similarly has the beneficial effects of the welding machine head, is capable of cleaning the welding slag online, is suitable for automatic slag cleaning of submerged arc welding of a horizontal long and straight weld, and is capable of liberating manpower, and compared with a traditional operation mode of one operator and one machine, one operator may operate multiple submerged arc welding devices, thereby effectively improving per capita work efficiency.

### BRIEF DESCRIPTION OF THE DRAWINGS

FIG. 1 is a schematic diagram of a structure of an embodiment of a welding slag cleaning device;

FIG. 2 is a schematic diagram of a structure of an embodiment of a slag crushing wheel and an adjusting assembly;

FIG. 3 is a schematic diagram of a structure of an embodiment of a recovery pipe;

FIG. 4 is a schematic diagram of a port of the recovery pipe shown in FIG. 3;

FIG. 5 is a schematic diagram of a structure of an embodiment of a welding machine head;

FIG. 6 is a front view of the embodiment of the welding machine head;

FIG. 7 is a cross section view of an A-A part of the embodiment shown in FIG. 6; and

FIG. 8 is a left view of the embodiment shown in FIG. 6.

### DETAILED DESCRIPTION

The concept and the generated technical effect of the present invention are clearly and completely described hereinafter with reference to the embodiments to fully understand the objectives, the features and the effects of the present invention. Apparently, the described embodiments are only some but not all of the embodiments of the present invention, and based on the embodiments of the present invention, other embodiments obtained by those skilled in the art without going through any creative work all belong to the scope of protection of the present invention.

In the description of the embodiments of the present invention, the orientation or position relationship indicated by the terms “up”, “down”, and the like is based on the orientation or position relationship shown in the accompanying drawings, it is only for the convenience of description of the present invention and simplification of the description, and it is not to indicate or imply that the indicated device or element must have a specific orientation, and be constructed and operated in a specific orientation. Therefore, the terms shall not be understood as limiting the present invention.

In the description of the embodiments of the present invention, if some feature is called “set” or “connected” on another feature, the feature may be directly set, fixed or connected to another feature, or indirectly set or connected on another feature. In the description of the embodiments of the present invention, if “several” is involved, the meaning of “several” refers to be one or more, and if “multiple” is involved, the meaning of “multiple” refers to be more than two, both of which shall be understood as not including this number, shall be understood as being used for distinguishing the technical features, and cannot be understood as indicating or implying relative importance, implicitly indicating the number of technical features indicated thereby, or implicitly indicating the order of technical features indicated thereby.

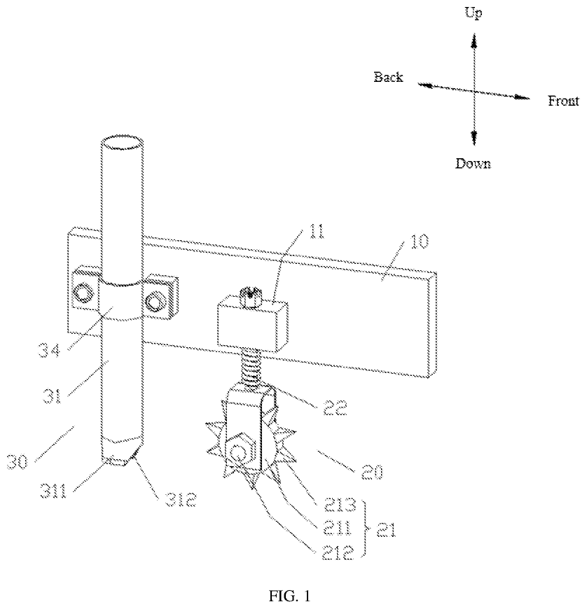

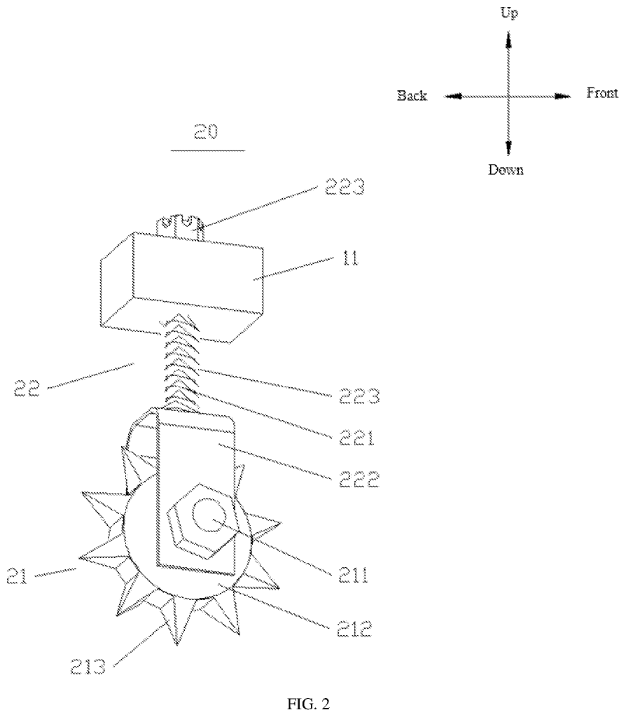

FIG. 1 is a schematic diagram of a structure of an embodiment of a welding slag cleaning device, and FIG. 2 is a schematic diagram of a structure of an embodiment of a slag crushing wheel and an adjusting assembly. With reference to FIG. 1 and FIG. 2 at the same time, the welding slag cleaning device of the embodiment includes a mounting frame 10, a slag crushing mechanism 20 and a welding slag recovery mechanism 30. The slag crushing mechanism 20 and the welding slag recovery mechanism 30 are connected to the mounting frame 10, the slag crushing mechanism 20 is configured to crush welding slag, and the welding slag recovery mechanism 30 is used for recovering the welding slag crushed by the slag crushing mechanism 20, thereby cleaning the welding slag.

According to reference directions marked in the drawings, a welding advancing direction is a front direction, two sides perpendicular to the advancing direction are respectively an up direction and a down direction, a front-back extending direction is a transverse direction, and an up-down extending direction is a longitudinal direction.

The slag crushing mechanism 20 includes a slag crushing wheel 21 and an adjusting assembly 22. The slag crushing wheel 21 is connected to the adjusting assembly 22, the adjusting assembly 22 is connected to the mounting frame 10, and the adjusting assembly 22 is configured to adjust a longitudinal distance of the slag crushing wheel 21 relative to the mounting frame 10.

The slag crushing wheel 21 includes a wheel axle 211 and a wheel body 212, and is rotationally connected to the adjusting assembly 22 through the wheel axle 211. Gear teeth 213 are distributed on the wheel body 212, and the gear teeth 213 are configured to crush the welding slag. In the embodiment, the gear teeth 213 are of a conical structure, which are capable of effectively crushing the welding slag, and when acting on the welding slag, the gear teeth are capable of effectively crushing the welding slag into fragments with a length of 1 cm to 2 cm.

The adjusting assembly 22 includes a guide rod 221, a mounting piece 222 and an elastic piece 223. The mounting piece 222 is connected to one end of the guide rod 221, and the slag crushing wheel 21 is rotationally connected to the mounting piece 222 through the wheel axle 211. The guide rod 221 is connected to the mounting frame 10 and is capable of moving relative to the mounting frame 10 in a longitudinal direction, and an upper end of the guide rod 221 is provided with a limiting structure 224. The guide rod 221 is arranged between the mounting frame 10 and the mounting piece 222, and the guide rod 221 has an elastic force to make the mounting piece 222 far away from the mounting frame 10 in the longitudinal direction. Therefore, the slag crushing mechanism 20 is capable of being flexibly adjusted with a change of a welding pass during welding, without hindering operation of the machine head, thus ensuring a stability of welding. A connecting block 11 used for connecting with the adjusting assembly 22 may be arranged on the mounting frame 10, thereby being convenient for quick connection and mounting.

In other embodiments, the adjusting assembly 22 may not be provided with the elastic piece. For example, the adjusting assembly 22 includes an adjusting piece and the mounting piece 222, the mounting piece 222 is connected to one end of the adjusting piece, and the slag crushing wheel 21 is rotationally connected to the mounting piece 222 through the wheel axle 211. The adjusting piece is connected to the mounting frame 10, and by adjusting a connection position of the adjusting piece to the mounting piece 222, a longitudinal distance of the mounting piece 222 relative to the mounting frame 10 is capable of being adjusted. The adjusting piece herein may be of a screw structure, which is threadedly connected to the mounting frame 10 to form a screw adjusting mechanism, and the slag crushing wheel 21 may be adjusted up and down in a longitudinal direction by rotating the adjusting piece.

The welding slag recovery mechanism 30 includes a hollow recovery pipe 31 and a connecting piece 34 used for connecting the recovery pipe 31 with the mounting frame 10, and the connecting piece 34 may be a fastener fastened with an outer wall of the recovery pipe 31. The recovery pipe 31 is correspondingly arranged right behind the slag crushing mechanism 20 in a transverse direction, so that the welding slag fragments may be cleaned after the slag crushing mechanism 20 crushes the welding slag. The hollow recovery pipe 31 may be communicated with a negative pressure air source, and the welding slag is sucked and removed by negative pressure suction.

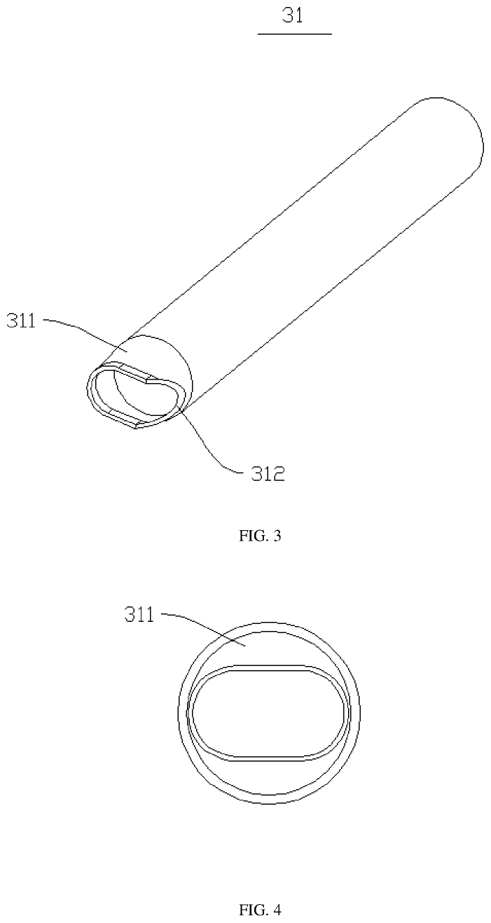

FIG. 3 is a schematic diagram of a structure of an embodiment of the recovery pipe, and FIG. 4 is a schematic diagram of a port of the recovery pipe shown in FIG. 3. With reference to FIG. 3 and FIG. 4, the recovery pipe 31 is of a hollow tubular structure, and a lower end port of the recovery pipe 31 is set as a convergent structure 311 to ensure that the port locally generates sufficient low negative pressure intensity. In welding of H-shaped steel on a ship-shaped position, two sides of the port are tangent to an H-shaped steel wing web. The lower end port of the recovery pipe 31 is convergent to form the convergent structure 311 with an elliptical or runway-shaped cross section. The convergent structure 311 of the embodiment has the runway-shaped cross section, with a length direction extending transversely, so that the welding slag is capable of being fully sucked. Regardless of whether the port is provided with the convergent structure 311, a chamfered opening 312 is formed at the front end of the lower end port of the recovery pipe 31, thereby preventing blockage.

By arranging the slag crushing mechanism 20 and the welding slag recovery mechanism 30 above, the welding slag cleaning device is capable of being suitable for slag crushing of single and double wire welding slags with different thicknesses, is suitable for automatic slag cleaning of submerged arc welding of a horizontal long and straight weld, and is capable of liberating manpower, and compared with a traditional operation mode of one operator and one machine, one operator may operate multiple submerged arc welding devices, thus effectively improving per capita work efficiency.

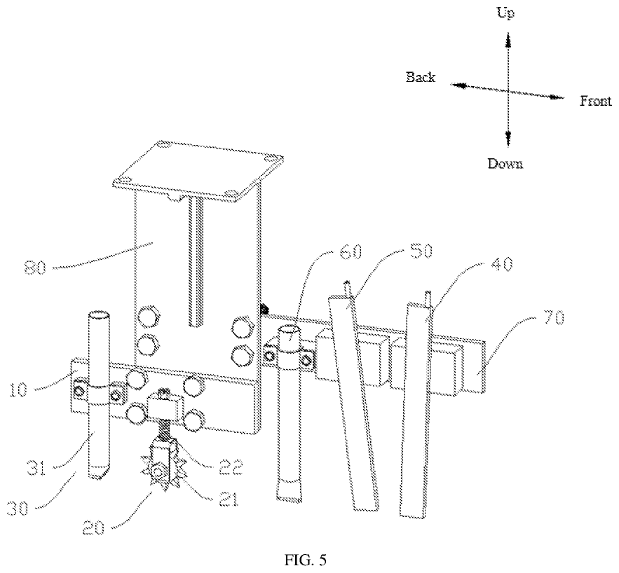

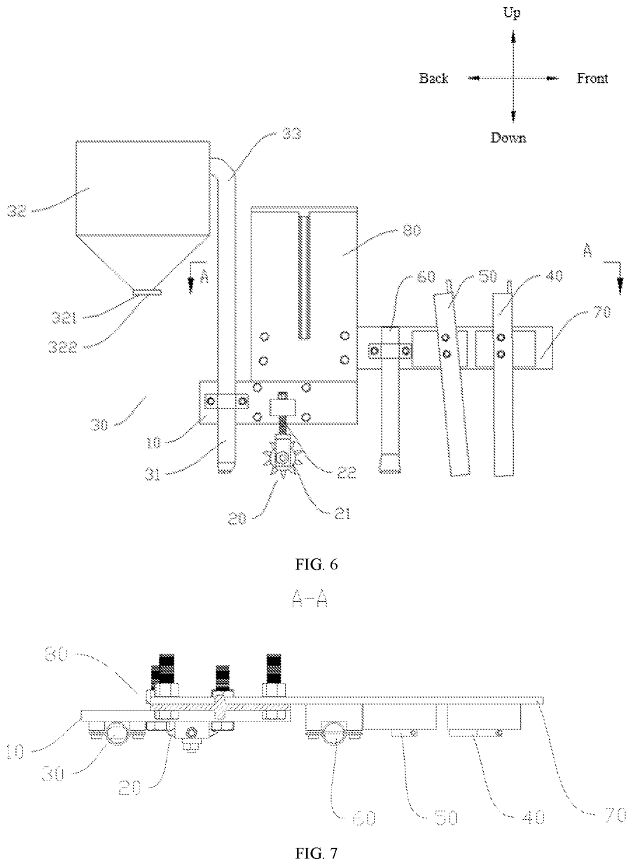

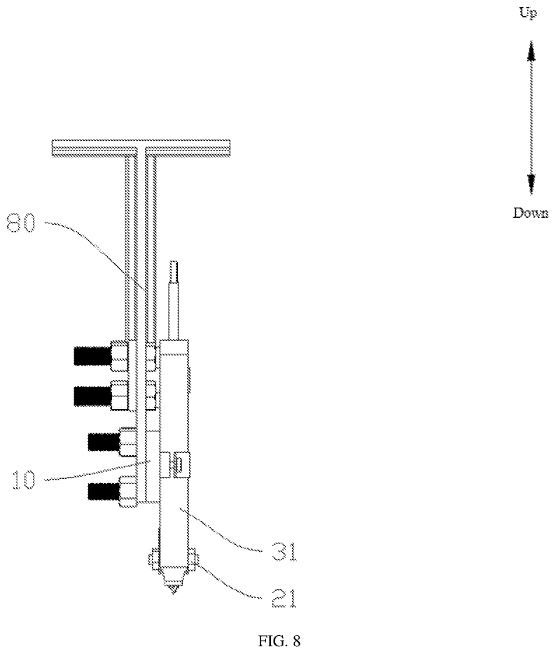

FIG. 5 is a schematic diagram of a structure of an embodiment of a welding machine head, FIG. 6 is a front view of the embodiment of the welding machine head, FIG. 7 is a cross section view of an A-A part of the embodiment shown in FIG. 6, and FIG. 8 is a left view of the embodiment shown in FIG. 6. With reference to FIG. 5 to FIG. 8 at the same time, the welding machine head of the embodiment includes a front wire welding gun 40, a rear wire welding gun 50, a welding flux recovery pipe 60 and the welding slag cleaning device according to any of the above embodiments which are sequentially arranged from front to back in a transverse direction. The slag crushing wheel 21 of the welding slag cleaning device is correspondingly located right behind the welding flux recovery pipe 60 in a transverse direction, so that welding, welding flux recovery and online cleaning of the welding slag are capable of being implemented, and a set distance is spaced between the slag crushing wheel 21 and the rear wire welding gun 50. The distance needs to be set reasonably according to specific needs, so that a distance between the slag crushing wheel 21 and a welding position is appropriate, thus avoiding the distance to be too short or too long. The distance may be adjusted experimentally in actual implementation to obtain a reasonable range of a distance value. If the distance is too short, the welding slag is not completely hardened and is still adhered to the weld, which is difficult to be crushed, and if the distance is too long, a size of the machine head is increased, which makes an operation inconvenient.

The welding slag recovery mechanism 30 may be provided with a recovery box 32, and the recovery box 32 is communicated with the recovery pipe 31 through a pipeline 33, and is communicated with a negative pressure air source through the recovery box 32 to provide negative pressure suction for the recovery pipe 31. The welding slag fragments are capable of being sucked through the recovery pipe 31, and reach the recovery box 32 through the pipeline. A bottom portion of the recovery box 32 is provided with a discharge port 321, and the discharge port 321 may be provided with an automatic control switch 322, which is used for controlling opening and closing of the discharge port 321. The automatic control switch 322 may be automatically turned on at a set position after multiple welds are welded or the welding slag recovery box 32 fully recovers the welding slag, thus discharging the welding slag in the recovery box 32.

The welding machine head includes a lifting arm 80 and a backboard 70 extending in a transverse direction. The front wire welding gun 40, the rear wire welding gun 50, the welding flux recovery pipe 60 and the welding slag cleaning device are all mounted on the backboard 70, so that an integrated welding machine head structure is implemented, deviation of a relative position of a certain mechanism is avoided, and an adjustment workload is increased. The backboard 70 is directly connected to the lifting arm 80, which facilitates adjustment of the machine head when necessary, and the machine head does not need to be adjusted for a long time during normal operation, thus reducing a number of adjustment shafts of the machine head, ensuring fixed and stable relative positions of mechanisms on the machine head, and improving an operation efficiency. The front wire welding gun 40, the rear wire welding gun 50, the welding flux recovery pipe 60, the slag crushing wheel 21 and the recovery pipe 31 are aligned with each other in a transverse direction, which is suitable for cleaning long welding slag online, so that the welding machine head is capable of being suitable for slag crushing of single and double wire welding slags with different thicknesses.

A welding system (not shown in the drawings) includes the welding machine head above, a frame and a recovery host for generating suction. The frame may be used as a mounting base of the welding machine head, and may also be used for fixing a workpiece to be welded at the same time to facilitate welding operation and welding slag cleaning operation of the welding machine head, and the recovery host is communicated with a recovery device, and is used for providing negative pressure suction for the recovery pipe. It can be known from the above embodiments that the welding slag is capable of being cleaned online through the welding system, the welding system is suitable for automatic slag cleaning of submerged arc welding of a horizontal long and straight weld, and is capable of liberating manpower, and compared with a traditional operation mode of one operator and one machine, one operator may operate multiple submerged arc welding devices, thus effectively improving per capita work efficiency.

The foregoing describes the preferred embodiments of the present invention in detail, but the present invention is not limited to the embodiments. Those skilled in the art may further make various equivalent modifications or substitutions without violating the spirit of the present invention, and these equivalent modifications or substitutions are all included in the scope defined by the claims of the present application. In addition, the embodiments of the present invention and the features in the embodiments may be combined with each other without conflict.

1-12. (canceled)

13. A welding slag cleaning device, comprising:
a mounting frame;
a slag crushing mechanism comprising a slag crushing wheel and an adjusting assembly, wherein the slag crushing wheel is connected to the adjusting assembly, the adjusting assembly is connected to the mounting frame, and the adjusting assembly is configured to adjust a longitudinal distance of the slag crushing wheel relative to the mounting frame; and
a welding slag recovery mechanism comprising a hollow recovery pipe and a connecting piece used for connecting the recovery pipe with the mounting frame, wherein the recovery pipe is correspondingly arranged right behind the slag crushing mechanism in a transverse direction.

14. The welding slag cleaning device of claim 13, wherein the slag crushing wheel comprises a wheel axle and a wheel body, and is rotationally connected to the adjusting assembly through the wheel axle; and wherein gear teeth are distributed on the wheel body, and the gear teeth are configured to crush the welding slag.

15. The welding slag cleaning device of claim 14, wherein the adjusting assembly comprises a guide rod, a mounting piece and an elastic piece, the mounting piece is connected to one end of the guide rod, and the slag crushing wheel is rotationally connected to the mounting piece through the wheel axle; wherein the guide rod is connected to the mounting frame and is capable of moving relative to the mounting frame in a longitudinal direction, and an upper end of the guide rod is provided with a limiting structure; and wherein the guide rod is arranged between the mounting frame and the mounting piece, and the guide rod has an elastic force to make the mounting piece far away from the mounting frame in a longitudinal direction.

16. The welding slag cleaning device of claim 14, wherein the adjusting assembly comprises an adjusting piece and a mounting piece, the mounting piece is connected to one end of the adjusting piece, and the slag crushing wheel is rotationally connected to the mounting piece through the wheel axle; and wherein the adjusting piece is connected to the mounting frame, and by adjusting a connected position of the adjusting piece to the mounting piece, a longitudinal distance of the mounting piece relative to the mounting frame is capable of being adjusted.

17. The welding slag cleaning device of claim 14, wherein the gear teeth are of a conical structure.

18. The welding slag cleaning device of claim 13, wherein a lower end port of the recovery pipe is set as a convergent structure.

19. The welding slag cleaning device of claim 18, wherein the lower end port of the recovery pipe is convergent to form the convergent structure with an elliptical or runway-shaped cross section.

20. The welding slag cleaning device of claim 13, wherein a front end of the lower end port of the recovery pipe is provided with a chamfered opening.

21. The welding slag cleaning device of claim 18, wherein a front end of the lower end port of the recovery pipe is provided with a chamfered opening.

22. The welding slag cleaning device of claim 19, wherein a front end of the lower end port of the recovery pipe is provided with a chamfered opening.

23. The welding slag cleaning device of claim 13, wherein the recovery device further comprises a recovery box, the recovery box is communicated with the recovery pipe through a pipeline, and the recovery box is used for connecting with a negative pressure air source to provide negative pressure suction for the recovery pipe.

24. A welding machine head, comprising a front wire welding gun, a rear wire welding gun, a welding flux recovery pipe and the welding slag cleaning device of claim 13 sequentially arranged from front to back in a transverse direction, wherein the slag crushing wheel is correspondingly located right behind the welding flux recovery pipe in the transverse direction, and a set distance is spaced between the slag crushing wheel and the rear wire welding gun.

25. The welding machine head of claim 24, comprising a lifting arm and a backboard extending in the transverse direction, wherein the backboard is directly connected to the lifting arm, the front wire welding gun, the rear wire welding gun, the welding flux recovery pipe and the welding slag cleaning device are all arranged on the backboard, and the front wire welding gun, the rear wire welding gun, the welding flux recovery pipe, the slag crushing wheel and the recovery pipe are aligned with each other in the transverse direction.

26. A welding system, comprising the welding machine head of claim 24.
